(19) United States
(12) Patent Application Publication
(10) Pub. No.: US 2019/0353129 A1
(43) Pub. Date: Nov. 21, 2019

(54) ELECTROMAGNETIC RELAY, MORE PARTICULARLY STARTER RELAY, AND METHOD FOR ACTUATING A STARTER DEVICE HAVING A STARTER RELAY

(71) Applicant: SEG Automotive Germany GmbH, Stuttgart (DE)

(72) Inventor: Karl-Otto SCHMIDT, Keltern (DE)

(21) Appl. No.: 16/479,367

(22) PCT Filed: Jan. 19, 2018
(86) PCT No.: PCT/EP2018/051344

§ 371 Date: Jul. 19, 2019

(30) Foreign Application Priority Data
Jan. 19, 2017 (DE) 10 2017 200 799.0

(51) Int. Cl. F02N 11/08; H01H 47/06; F02N 15/06; F02N 15/04

(52) U.S. Cl. CPC F02N 11/087; H01H 47/06; F02N 2011/0874; F02N 15/046; F02N 15/067

(57) ABSTRACT

The invention relates to an electromagnetic starter relay having an armature that is axially adjustably arranged, and having a pull-in winding, a hold-in winding and a switching winding. The hold-in winding is connected in series to the pull-in winding, wherein, in a phase stage of the meshing phase only the pull-in winding can be energised and in a different phase stage both the pull-in winding and the hold-in winding can be energised.

The invention relates to an electromagnetic relay, specifically a starter relay, to a starter device having a starter relay, and to a method for actuating the starter device having a starter relay.

### PRIOR ART

DE 10 2008 007 077 A1 describes a starter relay for a starter device, which is employed for the start-up of a combustion engine. The starter relay moves an axially displaceably-mounted starter pinion into an engaged position with a toothed wheel, whereafter an electric starter motor for the driving of the starter pinion is actuated. The starter relay comprises, in a housing, a displaceably-mounted lifting armature which, upon the energization of a pull-in winding, executes a travel motion, and displaces the starter pinion via a transmission lever. The starter relay further comprises a switching armature, to which a switching winding is assigned wherein, upon the energization of the switching winding, the switching armature is displaced, and switches on the electric starter motor.

In one embodiment variant, which is described in DE 10 2008 007 077 A1, additionally to the pull-in winding, a hold-in winding is further assigned to the lifting armature, which can be energized alternatively to the pull-in winding. For the forward motion of the lifting armature, firstly only the pull-in winding is energized and, once an intermediate position has been achieved, a switchover is then executed from the pull-in winding to the hold-in winding, which then retains the lifting armature in the intermediate position.

### DISCLOSURE OF THE INVENTION

The electromagnetic relay according to the invention comprises an axially displaceable armature, and a pull-in winding, a hold-in winding and a switching winding. Upon the energization of the pull-in winding, the armature is displaced between a starting position and a displaced position, wherein the displacement movement can be employed as a working motion or a drive motion, specifically for the displacement of a starter pinion in a starter device of a combustion engine. The hold-in winding is connected in series with the pull-in winding. In various phase stages, either only the pull-in winding is energized, or both the pull-in winding and the series-connected hold-in winding are energized in combination. The switching winding can be employed for the imposition of a switching motion upon an armature in the relay, specifically for the start-up of an electric motor.

The relay preferably comprises two different and separately configured armatures, of which the first armature constitutes a lifting armature, which is assigned to the pull-in winding and the hold-in winding, and the second armature constitutes a switching armature, which is assigned to the switching winding. The lifting armature and the switching armature are preferably arranged coaxially. However, embodiments are also possible in which only one armature is present in the relay, upon which the magnetic force of both the energized pull-in winding and hold-in winding, and of the energized switching winding acts. In any event, the switching winding is advantageously not energized until a time point at which the armature which is assigned to the pull-in and hold-in winding has already been displaced by the energization of one or both of these windings.

The series circuit arrangement of the pull-in winding and the hold-in winding provides an advantage, in that a strong magnetic force can be generated on the armature using a relatively small current. By virtue of their series connection, both the pull-in winding and the hold-in winding are energized during a specified phase stage, wherein the current magnitude is advantageously lower than in the event of the energization of the pull-in winding alone. The reduced current results in the reduced heat-up of the relay, thereby improving the service life of the relay.

The energization of the windings is executed by switches or transistors in the relay. By means of a corresponding actuation, the windings can be energized in a different manner in different phase stages of the meshing movement, either individually or in combination.

Advantageously, the pull-in winding and the hold-in winding are arranged in the same magnetic circuit. The pull-in winding and the hold-in winding can be arranged on the same winding carrier. Upon the actuation of the pull-in and hold-in windings, it is optionally possible for the hold-in winding to be energized independently of the pull-in winding such that, in a specific phase stage, only the hold-in winding is energized, and the pull-in winding is de-energized.

According to a further advantageous embodiment, the hold-in winding is dimensioned so as to be smaller than the pull-in winding and, for example, comprises a smaller number of turns than the pull-in winding such that, upon the energization of the hold-in winding only, a lower magnetic force is exerted, which acts upon the displaceable armature.

The pull-in winding and the hold-in winding are advantageously energizable in a mutually independent manner. This permits, specifically in the different phase stages in the course of the meshing phase, either the pull-in winding only, the hold-in winding only, or both the pull-in winding and the hold-in winding to be energized and, by means of currents of different magnitudes, different magnetic forces to be executed on the armature, such that the latter, in the different phase stages of the meshing phase, is accelerated more rapidly or more slowly, or is subject to a higher or lower magnetic force in the direction of displacement.

The armature is specifically loaded by the force of a spring element in the starting position such that, upon the energization of the pull-in winding and/or the hold-in winding, a magnetic force is exerted on the armature which counteracts the spring force.

The meshing phase comprises all the phase stages associated with the transition of the armature from its starting position to the displaced meshing position, which preferably constitutes the position of maximum displacement of the armature. The maintenance of the armature in the meshing position is also included in the meshing phase. In the case of a starter device and a starter relay, the starter pinion, in the meshing position, engages with the toothed wheel of the combustion engine.

The switching winding by means of which, in the case of an embodiment of the electromagnetic relay as a starter relay for a starter device, the electric starter motor can be started up, preferably operates in a separate magnetic circuit. The pull-in winding and the hold-in winding are thus arranged in a first magnetic circuit, and the switching winding in a second magnetic circuit.

In the method according to the invention for actuating a starter device which is equipped with an above-mentioned relay, the pull-in winding and the hold-in winding are energized in a different manner in different phase stages of the meshing phase. Advantageously, during a first phase stage of the meshing phase, only the pull-in winding in the starter relay is energized, such that a comparatively high current is active in the pull-in winding, and the pull-in winding exerts a comparatively strong magnetic force on the armature. As the meshing phase progresses further, in a further phase stage which succeeds the first phase stage, the series-connected hold-in winding is additionally energized. As a result, the current level in the pull-in winding and the hold-in winding drops, such that the heat-up of the starter relay is limited. The energization of the hold-in winding specifically occurs in a phase in which the armature has already achieved its meshing position, in which the starter pinion is engaged with the toothed wheel of the combustion engine. This phase can also be described as a waiting phase, which is assumed by the starter device when the combustion engine is switched off, but is to be restarted within a short time, for example when the vehicle in which the combustion engine comprising the starter device is installed stops at traffic lights.

Specifically in the embodiment with a separately configured lifting armature, which is assigned to the pull-in winding and the hold-in winding, and a switching armature, which is assigned to the switching winding for the switch-on of the electric starter motor, situations in which the combustion engine is to be restarted immediately after the switch-off thereof, can also be managed in an advantageous manner.

According to a further advantageous embodiment, the first phase stage of the meshing phase, in which only the pull-in winding is energized, is succeeded by a further phase stage, in which only the hold-in winding is energized. In this situation, the hold-in winding is energized in advance of the achievement of the position of maximum displacement of the armature such that, upon the energization of the hold-in winding, a magnetic actuating force acts on the armature, which moves the latter in the direction of the displaced position. Upon the energization of the hold-in winding, in comparison with the pull-in winding, a lower magnetic force acts on the armature, such that the latter is moved at a lower speed in the direction of the displaced position. In this phase stage, the loads in the starter relay, specifically with respect to the generation of heat, are reduced.

Optionally, the meshing process, if necessary, can be accelerated by the switchover of energization to the pull-in winding only, prior to the achievement of the position of maximum displacement. The meshing of the starter pinion with the toothed wheel of the combustion engine is achieved with a high degree of security a result.

If the starter device is in a waiting phase, in which the armature is in the meshing position and the starter pinion is engaged with the toothed wheel of the combustion engine, but the combustion engine is still switched off, it is appropriate that both the pull-in winding and the hold-in winding are energized, as a result of which the meshed position of the starter pinion is maintained, but a reduced current is active in the starter relay.

As soon as the combustion engine is to be started, the switching winding is energized, as a result of which the electric starter motor is started up.

Further advantages and appropriate embodiments proceed from the further claims, the description of the figures and the drawings. In the drawings:

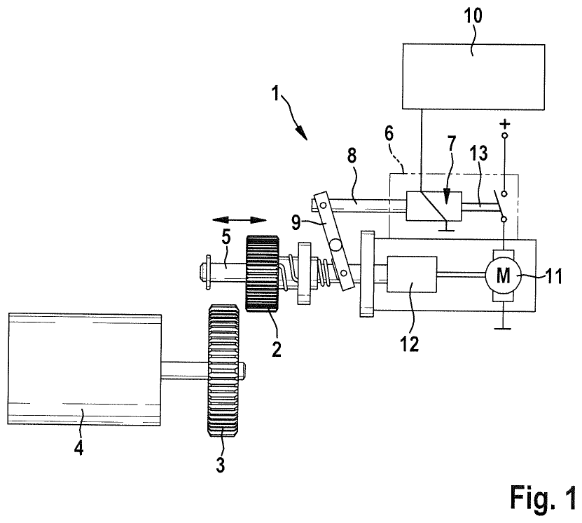

FIG. 1 shows a starter device for a combustion engine, having a starter relay for the displacement of a starter pinion,

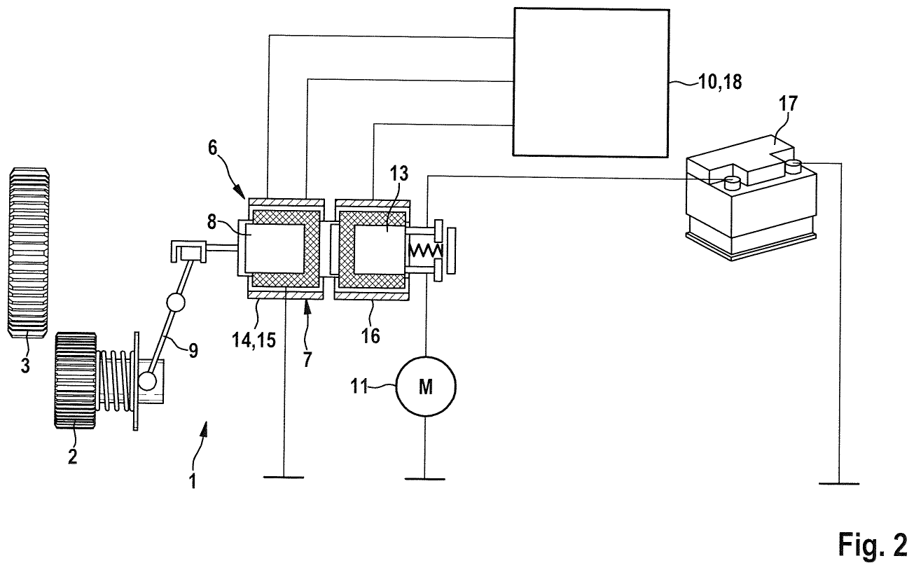

FIG. 2 shows the starter device, with a detailed representation of the starter relay,

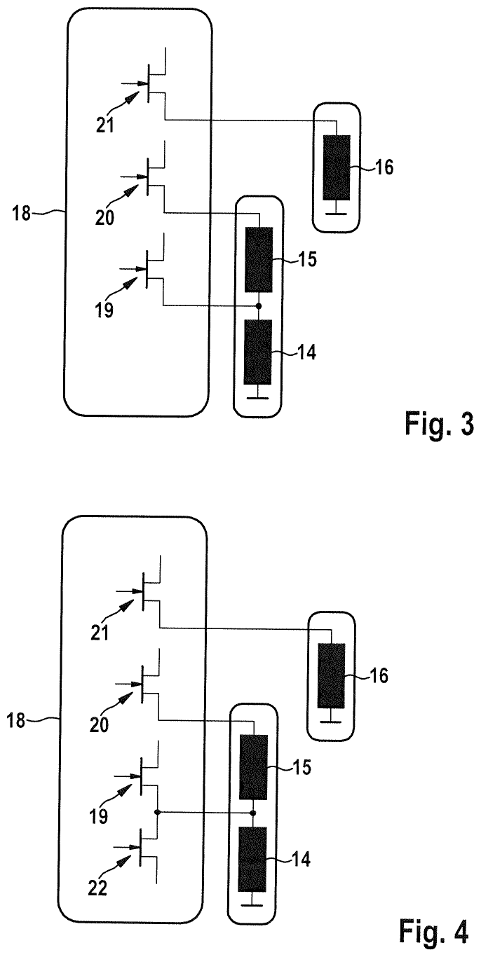

FIG. 3 shows the circuit layout of the starter relay,

FIG. 4 shows the circuit layout of the starter relay, in one embodiment variant.

In the figures, identical components are identified by the same reference numbers.

The starter device 1 for a combustion engine represented in FIG. 1 comprises a starter pinion 2 which, for the start-up of the combustion engine 4, is brought into engagement with a toothed wheel 3 of the combustion engine. The starter pinion 2 is axially displaceably mounted on a shaft 5, as indicated by the double-headed arrow, wherein the starter pinion 2 is coupled to the shaft 5 in a rotationally fixed manner. The starter pinion 2 is displaced between a withdrawn outer operating position and a forward engaged position with the toothed wheel 3 of the combustion engine 4 by means of a starter relay 6, which is electromagnetically configured and comprises energizable relay windings 7 and a lifting armature 8 which is loaded by spring force in a starting position and which, upon the energization of a pull-in winding, which is a constituent of the relay windings 7, is displaced into a meshing position. The lifting armature 8 is kinematically coupled to the starter pinion 2 by means of an engagement lever 9, such that the axial displacement motion of the lifting armature 8 between the starting position and the meshing position is translated into a corresponding axial travel motion of the starter pinion 2 between the outer operating position and the engaged position.

The rotary drive motion of the shaft 5 or the starter pinion 2 is generated by means of an electric starter motor 11, which is coupled to the shaft 5 via a planetary gear train 12. Upon the actuation of the electric starter motor 11, the shaft 5, and thus additionally the starter pinion 2, are set in rotation.

A control unit 10 is assigned to the starter device 1, by means of which the functions of the starter relay 6 and of the starter motor 11 are controlled.

Once the lifting armature 8 has achieved the meshing position, the electric current for the starter motor 11 can be switched-on wherein, in the starter relay 6, a switching winding is energized and a switching armature 13 is displaced. The switching winding is also a constituent of the relay windings 7. In the switched-on state, the starter motor 11 drives the shaft 5 and the starter pinion 2 in a rotary motion.

FIG. 2 represents the starter relay 6 in greater detail. The starter relay 6 comprises, in a housing, the lifting armature 8, to which two series-connected windings 14, 15 are assigned, of which the winding 14 constitutes a pull-in winding and the winding 15 constitutes a hold-in winding. The starter relay 6 moreover comprises the switching armature 13, which is configured separately from the lifting armature 8 and to which the switching winding 16 is assigned. The pull-in winding 14 and the series-connected hold-in winding 15 are arranged in a first magnetic circuit, which also incorporates the lifting armature 8 whereas, conversely, the switching winding 16 and the switching armature 13 are arranged in a second magnetic circuit. The energization of the pull-in winding 14, the hold-in winding 15 and the switching winding 16 is executed in a mutually independent manner by means of a circuit logic which is arranged in the control unit 10. The switching winding 16 is axially offset in relation to the pull-in winding 14 and the hold-in winding 15.

In a start-up process of the combustion engine, the pull-in winding 14 is energized, whereafter the lifting armature 8 is drawn into the pull-in winding 14 and the hold-in winding 15 and the engagement lever 9 is displaced, such that the starter pinion 2 meshes and engages with the toothed wheel 3 of the combustion engine. After meshing, the switching winding 16 is energized; the switching armature 13 is displaced, and an electrical contact is established, whereafter the starter motor 11, which is connected to the vehicle battery 17, is started up.

FIG. 3 represents a circuit logic, having a switching arrangement 18 for the actuation and energization of the pull-in winding 14, the hold-in winding 15 and the switching winding 16. The switching arrangement 18 can be a constituent of the control unit 10, or communicates with the control unit 10.

The control arrangement 18 comprises three switches 19, 20 and 21, of which the switches 19 and 20 are assigned to the pull-in winding 14 and the series-connected hold-in winding 15, and the switch 21 is assigned to the switching winding 16. By the assignment of two switches 19, 20 to the pull-in and hold-in windings 14, 15, various switching states and energizations of the windings 14, 15 can be achieved.

For the premeshing of the starter pinion into the meshed position with the toothed wheel of the combustion engine, the switch 19 is actuated and only the pull-in winding 14 is energized. Conversely, the hold-in winding 15 and the switching winding 16 initially remain in a de-energized state. Upon the achievement of the meshed position, if start-up is desired, the switch 21 is additionally actuated and the switching winding 16 is energized, whereafter the electric starter motor is actuated and the starter pinion is set in rotation. Once the combustion engine has been started, the windings 14 and 16 are disconnected.

By means of the switching arrangement 18 represented in FIG. 3, a waiting situation can also be achieved, for example when the vehicle is waiting at traffic lights, during which the combustion engine is switched off, but will require restarting within a short time. To this end, firstly, as described above, the switch 19 is actuated and the pull-in winding 14 is energized, until the pinion meshes with the toothed wheel of the combustion engine. Once the meshing position has been achieved, the switch 19 is switched off and the switch 20 is switched on in its place, whereafter both the pull-in winding 14 and the series-connected hold-in winding 15 are energized, but with a lower current. The starter pinion is meshed with the toothed wheel of the combustion engine, and remains in the meshed position as long as the switch 20 is switched on and the two windings 14 and 15 are energized in combination. As soon as a start-up is desired, the switching winding 16 is additionally energized by the switch-on of the switch 21, and the starter motor is set in rotation.

FIG. 4 represents an embodiment variant of the circuit logic having the switching arrangement 18 in which a further switch 22 is present, which is assigned to the combination of the pull-in winding 14 and hold-in winding 15. The function of the remaining switches 19 to 21 corresponds to that of the switches represented in FIG. 3.

The circuit logic represented in FIG. 4 permits a soft meshing of the starter pinion with the toothed wheel, at a reduced speed. To this end, in a first phase stage of the meshing phase, by the actuation of the switch 19, firstly only the pull-in winding 14 is energized, and the lifting armature accelerates at a relatively high speed. However, this first phase stage only lasts for a limited time, for example not exceeding 10 ms. This is succeeded by a second phase stage of the meshing phase, in which both the switch 20 and the switch 22 are switched on, but the switch 19 is switched off. With the switches 20 and 22 switched on, only the hold-in winding 15 is energized, whereas the pull-in winding 14 remains de-energized. The hold-in winding 15 dimensioned so as to be smaller than the pull-in winding 14 and, for example, is equipped with a smaller number of turns, such that the remainder of the meshing process is executed at a reduced speed.

Once the meshed position has been achieved, in which the starter pinion engages with the toothed wheel of the combustion machine, only the switch 20 is activated whereas, conversely, the further switches 19 and 22 are switched off. With the switch 20 activated, both the pull-in winding 14 and the hold-in winding 15 are energized, wherein the current magnitude is lower than in the event of the exclusive energization of the pull-in winding 14. This state for the maintenance of the meshed position, with the starter pinion engaged in the toothed wheel of the combustion engine, is maintained until a start-up is desired, whereafter the switching winding 16 is additionally energized by the switch-on of the switch 21.

For a normal starting process, with no waiting phase, in which the starter pinion is to be maintained in the meshed position with the toothed wheel, as represented in the exemplary embodiment according to FIG. 3, the pull-in winding 14 is energized by the activation of the switch 19 whereas, conversely, the hold-in winding 15 remains de-energized. Once the starter pinion has engaged with the toothed wheel, the switching winding 16 is additionally energized by the activation of the switch 21.

1. An electromagnetic relay, specifically a starter relay for a starter device of a combustion engine, having an axially displaceable armature with a pull-in winding, a hold-in winding and a switching winding, characterized in that the hold-in winding is connected in series with the pull-in winding wherein, in a phase stage of a meshing phase, only the pull-in winding can be energized and, in a further phase stage of the meshing phase, the pull-in winding and the hold-in winding can be energized in combination.

2. The relay as claimed in claim 1, characterized in that the pull-in winding and the hold-in winding are arranged in a same magnetic circuit.

3. The relay as claimed in claim 1, characterized in that the pull-in winding and the switching winding are arranged in different magnetic circuits.

4. The relay as claimed in claim 1, characterized in that the hold-in winding is dimensioned so as to be smaller than the pull-in winding.

5. The relay as claimed in claim 1, characterized in that the pull-in winding and the hold-in winding are energizable in a mutually independent manner.

6. A starter device for a combustion engine having a relay as claimed in claim 1 by way of a starter relay, and having an electric starter motor for the start-up of the combustion engine.

7. A method for actuating the starter device as claimed in claim 6 wherein, for meshing of a starter pinion with a toothed wheel of the combustion engine, in a first phase stage of the meshing phase, only the pull-in winding in the starter relay is energized and, as the meshing phase (14) progresses further, the hold-in winding is additionally energized, wherein the hold-in winding is connected in series with the pull-in winding.

8. The method as claimed in claim 7, characterized in that, subsequent to the first phase stage of the meshing phase, only the hold-in winding is energized.

9. The method as claimed in claim 7, characterized in that, in a final phase stage of the meshing phase, only the pull-in winding in the starter relay is energized.

10. The method as claimed in claim 7, characterized by the execution thereof on a switched-off combustion engine.

11. The method as claimed in claim 10, characterized in that, subsequent to expiry of a waiting phase for start-up of the combustion engine, the switching winding is additionally energized.
